(19) United States
(12) Patent Application Publication
(10) Pub. No.: US 2015/0096975 A1
(43) Pub. Date: Apr. 9, 2015

(54) HEATING DEVICE

(71) Applicant: CANON KABUSHIKI KAISHA, Tokyo (JP)

(72) Inventor: Makoto Ogusu, Yorktown, VA (US)

(21) Appl. No.: 14/488,487

(22) Filed: Sep. 17, 2014

(30) Foreign Application Priority Data
Oct. 8, 2013 (JP) 2013-210797

(51) Int. Cl. H05B 3/12; B32B 38/10; B32B 37/18; H05B 3/22

(52) U.S. Cl. CPC H05B 3/12; H05B 3/22; B32B 38/10; B32B 37/18
USPC 219/539; 156/247

(57) ABSTRACT

Provided is a heating device, including: a first heating region including a first material; and a second heating region including a second material, the second heating region having a smaller temperature coefficient of resistance than a temperature coefficient of resistance of the first heating region, the first heating region and the second heating region being connected to each other.

### BACKGROUND OF THE INVENTION

1. Field of the Invention

The present invention relates to a heating device.

2. Description of the Related Art

In recent years, research and development have been vigorously conducted on a technology called a micro total analysis system (μ-Tas), in which all elements necessary for chemical or biochemical analysis are integrated on one chip. In μ-Tas, such a chip is generally called a microfluidic device, and includes a microchannel, a temperature control mechanism, a concentration adjusting mechanism, a liquid feeding mechanism, a reaction detecting mechanism, and the like.

Microfluidic devices have been vigorously developed in recent years. Among others, a DNA analysis device aiming at examination to obtain genetic information such as a single nucleotide polymorphism (SNP) of a human genome is particularly attracting attention, and research thereof is vigorously conducted.

DNA analysis involves the following two steps: (1) a step of amplifying DNA; and (2) a step of determining the DNA.

Polymerase chain reaction (PCR) is generally used in (1) the step of amplifying DNA. This is a method of amplifying DNA by mixing a primer complementary to a part of the DNA to be amplified and an enzyme or the like with the DNA to be amplified and subjecting the mixture to a thermal cycle. This step requires accurate and high speed temperature control for the purpose of shortening reaction time.

There are many ways to perform (2) the step of determining the DNA. For example, a thermal melting method may be used in determining a SNP. The thermal melting method is a method of detecting a melting temperature (hereinafter referred to as Tm) of DNA by gradually raising a temperature of a DNA solution after PCR. When the temperature is low, DNA intercalated with a fluorochrome forms a double strand, and thus, a fluorescent signal is detected. After that, the temperature gradually rises, and, when the temperature reaches Tm, the double-stranded DNA is separated into single strands, and thus, the intensity of the fluorescent signal is abruptly lowered. Tm is determined based on this relationship between the temperature and the fluorescent signal, to thereby detect the SNP. In this step, the DNA is determined by comparing values of Tm, and thus, accurate temperature measurement is required.

As described above, when DNA is analyzed, temperature control is important, and in particular, high speed and accuracy are required for the temperature control.

Japanese Patent Application Laid-Open No. 2012-193983 discloses a microfluidic device including a microchannel and heaters arranged along the channel for the purpose of causing temperature change in the microchannel at high speed.

Using a microfluidic device leads to a significant advantage from the viewpoint of attaining high speed temperature control. Various kinds of reaction occur in a microchannel having a small thermal capacity, and thus, high speed heating and cooling are possible.

Further, in Japanese Patent Application Laid-Open No. 2012-193983, for the purpose of performing accurate temperature control in the microfluidic device, in particular, for the purpose of measuring a temperature in the channel, resistors serving both as the heaters and as temperature sensors are arranged below the microchannel, and temperature control is performed by associating the temperature in the channel and a resistance value of the resistor. Platinum is used as a material of the heaters, and all the heaters are formed so as to have the same structure.

The microfluidic device has an advantage in that, because elements forming the device have small thermal capacities, heat can be transferred at higher speed, and thus, temperature control can be performed at high speed. On the other hand, for the purpose of attaining uniform temperature control, it is necessary to apply heat using a heater that is larger than a target region. A resistance value of the heater, which changes as the temperature rises, is in one-to-one correspondence with a temperature at the center of the heater. In Japanese Patent Application Laid-Open No. 2012-193983, the resistance value of the heater in relation to a target temperature is grasped in advance by utilizing the above-mentioned correspondence, and thus, the temperature can be determined through measurement of the resistance value. The temperature measurement in Japanese Patent Application Laid-Open No. 2012-193983 is based on the premise that a temperature distribution of all the heaters is also in one-to-one correspondence with the measured temperature. In actuality, when an ambient temperature of the chip changes to cause the temperature of the chip to deviate from that when a calibration is performed, as a matter of course, the temperature distribution of part of the heaters may deviate from that when the calibration is performed. Therefore, there is a growing need for a technology of more accurately controlling the temperature distribution.

### SUMMARY OF THE INVENTION

According to one embodiment of the present invention, there is provided a heating device, including: a first heating region including a first material; and a second heating region including a second material, the second heating region having a smaller temperature coefficient of resistance than a temperature coefficient of resistance of the first heating region, the first heating region and the second heating region being connected to each other.

According to the heating device of one embodiment of the present invention, influence of temperature change around the device can be inhibited.

Further features of the present invention will become apparent from the following description of exemplary embodiments with reference to the attached drawings.

### BRIEF DESCRIPTION OF THE DRAWINGS

FIG. 1 is a top view illustrating a concept of a first embodiment of the present invention.

FIG. 2 is a view illustrating a structure of a metal film according to the first embodiment of the present invention.

FIG. 3 is a view illustrating a structure of a metal film according to a second embodiment of the present invention.

FIG. 4 is a top view illustrating a concept of a fourth embodiment of the present invention.

FIG. 5 is a top view illustrating a concept of a fifth embodiment of the present invention.

FIG. 6 is a sectional view illustrating the concept of the fifth embodiment of the present invention.

### DESCRIPTION OF THE EMBODIMENTS

The present invention is described in detail below.

The present invention is described in more detail by way of the following examples.

### First Example

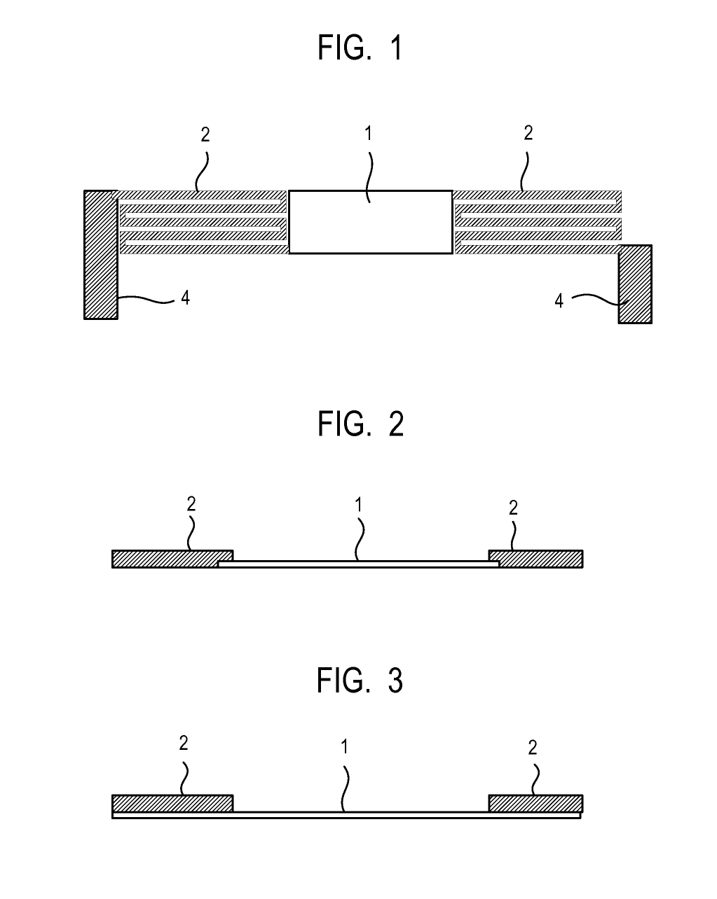

FIG. 1 is a top view illustrating a concept of a heating device according to a first example of the present invention. The heating device according to this example includes a first heating region 1 and two second heating regions 2 arranged with the first heating region 1 interposed therebetween. The two second heating regions 2 and the first heating region 1 are arranged in a line.

The first heating region 1 serves both to apply heat and to measure a temperature, and is formed of a platinum thin film having a width and a thickness designed so that a length of 1 mm thereof has a resistance of about 7Ω. In this case, the thickness is about 100 nm and the width is 300 μm. The second heating regions 2 are provided on respective end sides of the heating device with respect to the first heating region 1. The second heating regions 2 are formed by folding a gold thin film four times in a longitudinal direction. The second heating regions 2 have a thickness of about 200 nm and a width of 95 μm, and are designed so that a length of 1 mm thereof has a resistance of about 7Ω. Note that, FIG. 1 is a conceptual view and is not accurately scaled according to this example. Space between patterns formed by the folding is 10 μm. In a heating device, generally, it is desired that heat sources have a fixed size and be arranged uniformly. Therefore, the space between the film patterns formed by the folding has a smallest possible dimension that is allowable in the manufacturing process. This enables the entire second heating regions 2 to have substantially the same amount of heat thereacross. Lead patterns 4 for supplying power, which are also formed of gold, are formed outside the patterns formed by folding the gold thin film so as to have a width of 95 μm. The lead patterns 4 are designed so as to have a thickness of about 200 nm and a width of 300 μm or more. Note that, the dimensions of the lead patterns 4 may be selected insofar as heat generated outside the patterns having a width of 95 μm does not cause a problem in the light of a purpose in actual usage. The first heating region 1 and the second heating regions 2 are formed of different materials, and thus, in order to realize electrical connection, connecting portions are formed under a state in which the first heating region 1 and the second heating regions 2 overlap each other to an extent that a positional error in the process is allowable. FIG. 2 is a sectional view of the heating device illustrated in FIG. 1. In FIG. 2, part of the second heating regions 2 is positioned over the first heating region 1 (a surface of the device, which undergoes temperature change).

A heater having a finite size actually has such a temperature distribution that the temperature drops at ends thereof. In a system of determining a temperature by measuring a resistance value of the entire heating device, the correspondence between the temperature and the resistance value under certain conditions is determined in advance even empirically or theoretically. However, among the preconditions, when an ambient temperature changes, the change in ambient temperature causes change in temperature distribution particularly at the ends of the heater, and thus, the correspondence between the resistance value and the temperature may deviate from the correspondence determined in advance. In general, the heating device is formed so that the change is small at the center of the heaters having a most uniform temperature distribution, and thus, being highly likely to be used for various purposes. As a result, influence of the change in ambient temperature is significant particularly at the ends. Change in temperature distribution at the ends due to the influence of the temperature change causes fluctuation in the resistance value of the heating device, resulting in a deviation.

Therefore, according to this example, the heater has a structure including the first heating region 1 and the second heating regions 2, and thus, uniformity of generated heat is improved. Comparing average temperature coefficients between the volume resistivity at 0° C. and the volume resistivity at 100° C., platinum has an average temperature coefficient of 3.79 (10⁻³/° C.), while gold has an average temperature coefficient of 0.83 (10⁻³/° C.), which is about 1/4.5 as small as that of platinum. That is, in this example, the heater at the center of the heating device is formed of platinum so that the resistance value linearly changes with respect to the temperature. Further, the heaters formed of gold are formed at the end sides of platinum so that the resistance value thereof is substantially equal to that of the heater formed of platinum. In this way, a substantially uniform heat generation distribution is realized. In this case, change in resistance value of gold with respect to temperature change is about 1/4.5 as small as that of platinum. Therefore, even when the temperature distribution is changed due to change in ambient temperature, influence thereof at the ends can be reduced to about 1/4.5 compared with a case of a related-art heating device. In this way, the center portion serves to apply heat and to measure the temperature, and the peripheral portions formed of a material having a smaller temperature coefficient of resistance than that of the center portion serve to apply heat, with the result that the influence of ambient temperature can be reduced. Note that, the materials to be used for the first heating region 1 and the second heating regions 2 are not limited to platinum and gold, respectively, and it suffices that the materials be used for heating and the temperature coefficients of resistance of the materials be different from each other.

### Second Example

FIG. 3 illustrates a second example of the present invention. The first heating region 1 is formed of platinum, and the second heating regions 2 are formed of gold. Platinum and gold are materials that are very difficult to process in a dry process. Therefore, a process called lift-off is often used. In this example, as illustrated in FIG. 3, platinum is arranged on a front surface of the pattern (a surface of the device, which does not undergo temperature change). Further, in the second heating regions that are desired to be formed of gold, gold is laminated over platinum (the surface of the device, which undergoes temperature change) to form a laminated structure of platinum and gold. By laminating gold on platinum in this way and then removing gold in a portion corresponding to the first heating region 1 by etching or the like, the heating device can be manufactured. The patterning for forming a metal pattern can be performed at a time, which can further simplify the manufacturing process of the heating device.

In the structure of this example, at positions where gold and platinum are laminated, the sheet resistance value of gold is smaller than that of platinum by an order of magnitude, and thus, the influence of the platinum layer laminated as an underlayer is substantially negligible. The heating device according to this example also functions satisfactorily.

### Third Example

In a third example of the present invention, the pattern size of gold in plan view and the thickness of gold are changed. In the first example, the thickness of gold of the power supply leads does not differ from that in the heater regions for generating heat. In this example, the thickness of gold in the second heating regions 2, which are folded thin lines and serve as heating portions, is set smaller. As a result, not only the width of the patterns but also the thickness becomes a parameter, which increases the degree of design freedom. Such a structure can allow the second heating regions 2 to satisfactorily function as regions for applying heat and can reduce the number of space portions between the patterns formed by the folding in the regions for forming the heaters.

### Fourth Example

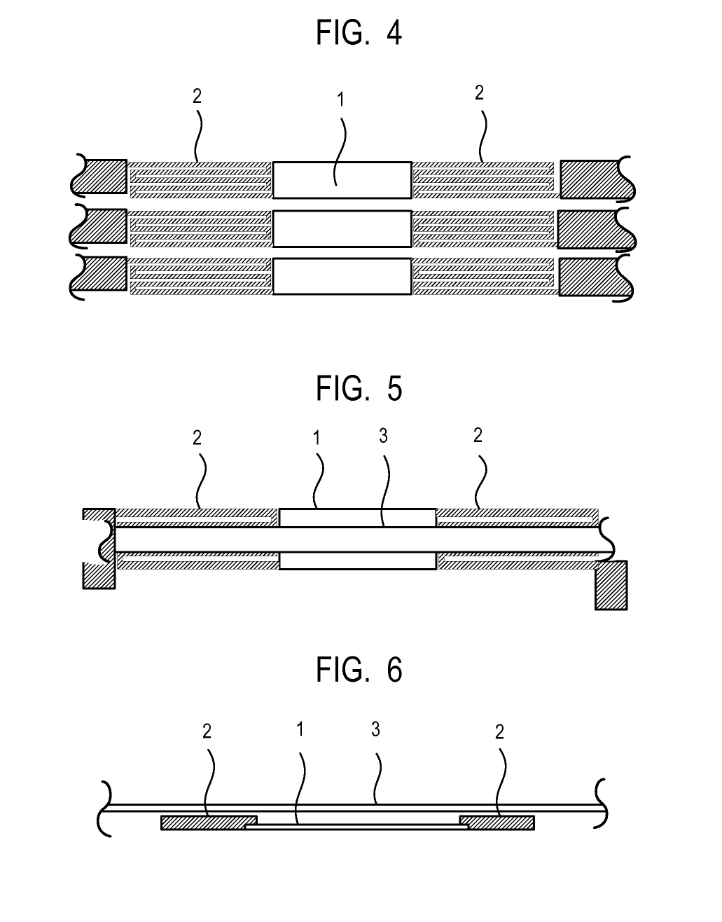

FIG. 4 illustrates a fourth example of the present invention. FIG. 4 is a top view illustrating a concept of a heating device according to this example, in which a plurality of heating devices as described in the first to third examples are arranged so as to extend in a transverse direction. Such heating devices perform parallel processing, and thus, are particularly useful for attaining higher speed processing of the entire system. In this example, the devices are arranged in parallel with one another, and thus, uniformity of temperature in a repeating direction is improved. However, in order to attain this improvement, it is desired that space between the heating devices be as small as possible and that the devices be densely arranged. When the devices are arranged for the purpose of attaining parallel processing in this way, it is difficult to provide a temperature measurement unit solely for the purpose of measuring a temperature, and it is particularly useful both to serve to apply heat and to measure the temperature. In this example, the influence of change in ambient temperature on the result of the temperature measurement can be minimized.

### Fifth Example

FIG. 5 and FIG. 6 illustrate a fifth example of the present invention. FIG. 5 is a top view illustrating a concept of heating devices according to this example, and FIG. 6 is a sectional view thereof. Channels 3 are provided above heating devices, respectively, as described in the first to third examples (the surfaces of the devices, which undergoes temperature change), and the heating devices are used to heat the channels 3.

The two second heating regions 2 and the first heating region 1 interposed between the second heating regions 2 are arranged in a line along the channel.

A plurality of channels are provided, and one first heating region 1 and two second heating regions 2 are provided for each channel.

In this example, using a step of calibrating in advance the temperature of the channel and the resistance value of the heater, the temperature of the channel 3 can be determined based on the resistance value of the heater, which is obtained by measuring the temperature of the heater by the first heating region 1. Also in this example, even when the ambient temperature when the calibration is performed and the ambient temperature in actual use differ from each other, the influence of the ambient temperature can be reduced to satisfactorily perform temperature control of the channel 3 through heat application and temperature measurement.

In this case, the channels 3 are formed as microchannels having a channel diameter of, for example, less than 1 mm, and thus, the channels can hold a trace of liquid. Further, the volume of an object to be heated is reduced to enable high speed temperature change.

The examples described above are merely examples of the present invention, and the present invention is not limited thereto and various modifications may be made thereto.

Specifically, a plurality of first heating regions and a plurality of second heating regions may be arranged for one linearly extending channel.

In other words, the heating device may include at least two first heating regions 1 and at least four second heating regions 2 arranged for each channel thereof.

For example, on an upstream side of the channel, the first heating region 1 and the second heating regions 2 described above are arranged as heating regions for applying a temperature cycle of PCR. On a downstream side of the channel, similarly, a corresponding third heating region (which corresponds to the first heating region) and fourth heating regions (which correspond to the second heating regions) are arranged as heating regions for measuring the melting temperature. This enables reaction measurement using two different kinds of heating of one channel.

While the present invention has been described with reference to exemplary embodiments, it is to be understood that the invention is not limited to the disclosed exemplary examples. The scope of the following claims is to be accorded the broadest interpretation so as to encompass all such modifications and equivalent structures and functions.

This application claims the benefit of Japanese Patent Application No. 2013-210797, filed Oct. 8, 2013, which is hereby incorporated by reference herein in its entirety.

What is claimed is:

1. A heating device, comprising:
a first heating region comprising a first material; and
a second heating region comprising a second material, the second heating region having a smaller temperature coefficient of resistance than a temperature coefficient of resistance of the first heating region,
the first heating region and the second heating region being connected to each other.

2. A heating device according to claim 1, wherein the second heating region is provided on an end side of the heating device with respect to the first heating region.

3. A heating device according to claim 1, wherein the first heating region measures a temperature.

4. A heating device according to claim 1, wherein the second heating region is formed by laminating the first material and the second material, and the second material is laminated on a surface of the first material, on which the heating device undergoes temperature change.

5. A heating device according to claim 1, wherein the first material comprises platinum, and the second material comprises gold.

6. A heating device according to claim 1, further comprising a channel.

7. A heating device according to claim 1, wherein the second heating region comprises two second heating regions arranged with the first heating region interposed therebetween.

8. A heating device according to claim 7, wherein the two second heating regions and the first heating region are arranged in a line.

9. A heating device according to claim 6, wherein the two second heating regions and the first heating region interposed between the two second heating regions are arranged in a line along the channel.

10. A heating device according to claim 9,
wherein the channel comprises a plurality of channels, and
wherein the first heating region and the two second heating regions are arranged for each of the plurality of channels.

11. A heating device according to claim 10,
wherein the first heating region comprises at least two first heating regions arranged for the each of the plurality of channels, and
wherein the second heating region comprises at least four second heating regions arranged for the each of the plurality of channels.

12. A heating device according to claim 6, wherein the channel comprises a microchannel.

13. A method of manufacturing the heating device according to claim 4, the method comprising:
laminating the second material on the first material; and
removing a portion of the second material corresponding to the first heating region.
